(19) United States
(12) Patent Application Publication
(10) Pub. No.: US 2017/0370589 A1
(43) Pub. Date: Dec. 28, 2017

(54) MULTI-TUBE LATE LEAN INJECTOR

(71) Applicant: General Electric Company, Schenectady, NY (US)

(72) Inventors: Jonathan Dwight BERRY, Greenville, SC (US); Michael John HUGHES, Greenville, SC (US)

(21) Appl. No.: 15/189,708

(22) Filed: Jun. 22, 2016

(51) Int. Cl. F23R 3/28; F02C 7/22; F02C 7/228; F23R 3/34

(52) U.S. Cl. CPC F23R 3/286; F23R 3/346; F02C 7/222; F02C 7/228

(57) ABSTRACT

A micromixer injector includes a fuel plenum to receive a supply of fuel. A plurality of premixing tubes extend through the fuel plenum. Each tube has a plurality of fuel holes formed therein to receive the supply of fuel for mixing with air in the tube. The micromixer has a tapering profile such that an overall inlet area of the plurality of premixing tubes on an upstream face of the micromixer is larger than an overall outlet area of the plurality of premixing tubes on a downstream face such that the plurality of premixing tubes are relatively spaced-apart at the upstream face and more densely packed at the downstream face. Additionally, an air inlet of each tube has a first geometrical shape and the outlet of each tube has a second geometrical shape that is different from the first geometrical shape.

### STATEMENT REGARDING FEDERALLY SPONSORED RESEARCH OR DEVELOPMENT

This invention was made with Government support under Contract No. DE-FE0023965 awarded by the United States Department of Energy. The Government has certain rights in this invention.

### TECHNICAL FIELD

This invention relates generally to a combustion system and, more specifically, to a combustion system that comprises a primary reaction zone and a secondary reaction zone, which includes an injector for injecting a fluid into a stream of combustion products generated within the primary reaction zone.

### BACKGROUND

Fuel is delivered from a fuel source to a combustion section of a gas turbine where the fuel is mixed with air and ignited to generate hot combustion products. The hot combustion products are working gases that are directed to a turbine section where they effect rotation of a turbine rotor. It has been found that the production of NOx gases from the burning fuel in the combustion section can be reduced by providing a secondary combustion zone downstream from a main combustion zone. The fuel-air mixture provided to the secondary combustion zone may be a lean mixture.

### BRIEF SUMMARY

One aspect of the disclosed technology relates to a micromixer injector having a compact arrangement including a plurality of premixing tubes having a spaced-apart configuration at an upstream face of the micromixer and a more densely packed arrangement at a downstream face.

One exemplary but nonlimiting aspect of the disclosed technology relates to a micromixer injector comprising a fuel plenum to receive a supply of fuel; a plurality of premixing tubes extending through the fuel plenum, each tube having an air inlet at an intake end of the tube and an outlet at a discharge end of the tube, the air inlet of each tube being configured to receive a supply of air, each tube having a plurality of fuel holes formed therein to receive the supply of fuel for mixing with the air in the tube; and an upstream face having the inlet of each tube formed therein, and a downstream face having the outlet of each tube formed therein, wherein the air inlet of each tube has a first geometrical shape and the outlet of each tube has a second geometrical shape that is different from the first geometrical shape, and wherein an overall inlet area of the plurality of premixing tubes on the upstream face is larger than an overall outlet area of the plurality of premixing tubes on the downstream face such that the plurality of premixing tubes are relatively spaced-apart at the upstream face and more densely packed at the downstream face.

Another exemplary but nonlimiting aspect of the disclosed technology relates to a combustor section comprising a primary combustion system generating a stream of combustion products: a secondary combustion system located downstream of the primary combustion system, the secondary combustion system including: at least one micromixer injector to deliver a fuel air mixture into the stream of combustion products, the at least one micromixer injector comprising: a fuel plenum to receive a supply of fuel; a plurality of premixing tubes extending through (be fuel plenum, each tube having an air inlet at an intake end of the tube and an outlet at a discharge end of the tube, the air inlet of each tube being configured to receive a supply of air, each tube having a plurality of fuel holes formed therein to receive the supply of fuel for mixing with the air in the tube; and an upstream face having the inlet of each tube formed therein, and a downstream face having the outlet of each tube formed therein, wherein the air inlet of each tube has a first geometrical shape and the outlet of each tube has a second geometrical shape that is different from the first geometrical shape, and wherein an overall inlet area of the plurality of premixing tubes on the upstream face is larger than an overall outlet area of the plurality of premixing tubes on the downstream face such that the plurality of premixing tubes are relatively spaced-apart at the upstream lace and more densely packed at the downstream face.

Other aspects, features, and advantages of this technology will become apparent from the following detailed description when taken in conjunction with the accompanying drawings, which are a pan of this disclosure and which illustrate, by way of example, principles of this invention.

### BRIEF DESCRIPTION OF THE DRAWINGS

The accompanying drawings facilitate an understanding of the various examples of this technology. In such drawings:

FIG. 1 is a partial cross-sectional side view of a turbomachine in accordance with an example of the disclosed technology;

FIG. 2 is a cross-sectional side view of an example of the combustor of the turbomachine of FIG. 1;

FIG. 3 is an enlarged detail of FIG. 2;

FIG. 4 is a front perspective view of a micromixer slot injector according to an example of the disclosed technology;

FIG. 5 is rear perspective view of the micromixer slot injector of FIG. 4;

FIG. 6 is another rear perspective view of the micromixer slot injector of FIG. 4;

FIG. 7 is a partial rear perspective view of a micromixer according to another example of the disclosed technology;

FIG. 8 is a left side view of the micromixer slot injector of FIG. 4;

FIG. 9 is a right side view of the micromixer slot injector of FIG. 4;

FIG. 10 is a top view of the micromixer slut injector of FIG. 4;

FIG. 11 is a front view of the micromixer slot injector of FIG. 4;

FIG. 12 is a cross-sectional front perspective view along the line 12-12 in FIG. 10;

FIG. 13 is a cross-sectional rear perspective view along the line 13-13 in FIG. 8;

FIG. 14 is a cross-sectional front perspective view along the line 13-13 in FIG. 8;

FIG. 15 is a cross-sectional front perspective view along the line 15-15 in FIG. 11;

FIG. 16 is a cross-sectional front perspective view along the line 16-16 in FIG. 10; and

FIG. 17 is a schematic representation illustrating flow paths of fluids used in the secondary combustion system, in accordance with an example of the disclosed technology.

### DETAILED DESCRIPTION OF THE ILLUSTRATED EMBODIMENTS

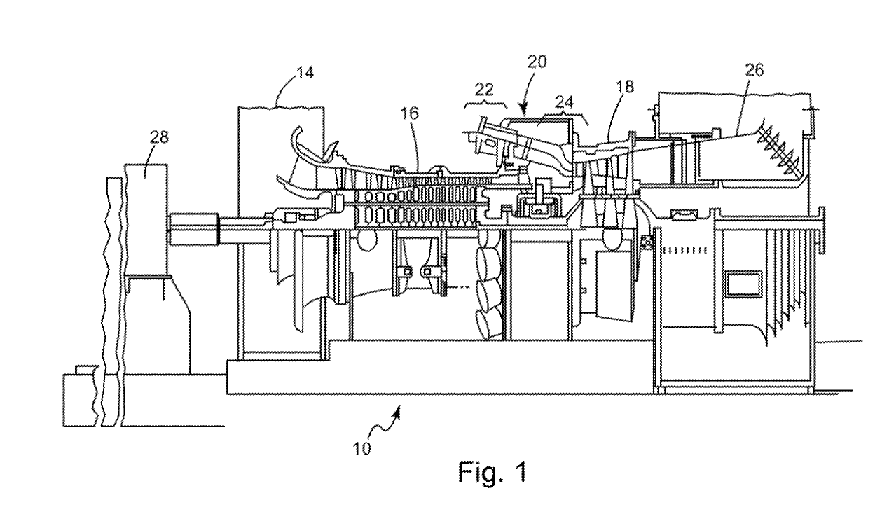

FIG. 1 is a partial cross-sectional side view of a turbomachine 10 in accordance with an embodiment of the disclosed technology. The turbomachine 10 may comprise a primary combustion system 22 and a secondary combustion system 24 including at least one micromixer slot injector 200, (not illustrated in FIG. 1), for injecting a secondary fluid, into a stream of combustion products generated by the primary combustion system 22.

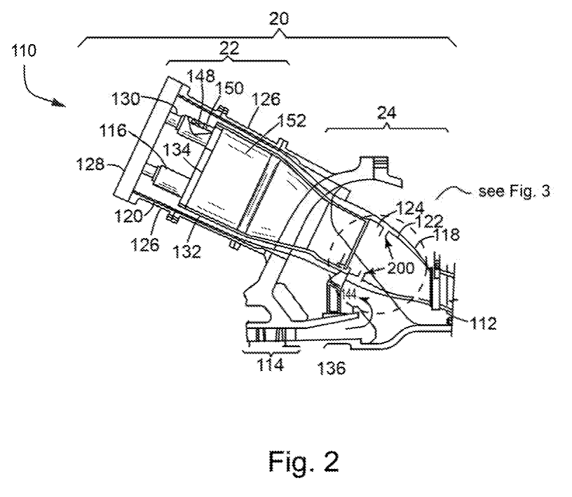

An embodiment of the turbomachine 10 may comprise an inlet section 14; a compressor section 16 downstream from the inlet section 14; a combustion section 20 comprising the primary combustion system 22 downstream from the inlet section 14, and the secondary combustion system 24 downstream from the primary combustion system 22; a turbine section 18 and an exhaust section 26. As illustrated in FIG. 2, for example, the secondary combustion system 24 may comprise at least one micromixer slot injector 200 for injecting a secondary fluid, such as, but not limited to, a fuel and air mixture, into a stream of combustion products flowing from the primary combustion system 22.

Referring again to FIG. 1, the turbomachine 10 may also include a turbine section 18. The turbine section 18 may drive the compressor section 16 and the load 28 through a common shaft connection. The load 28 may be, but is not limited to, an electrical generator, a mechanical drive or the like.

The combustion section 20 may include a circular array of a plurality of circumferentially spaced combustors 110. A fuel and air mixture may be burned in each combustor 110 lo produce a stream of combustion products, which may flow through a transition piece 122 and then to a plurality of turbine nozzles 112 of the turbine section 18. A conventional combustor 110 is described in U.S. Pat. No. 5,259,184. For purposes of the present description, only one combustor 110 may be referenced, all of the other combustors 110 arranged about the combustion section 20 may be substantially identical to the illustrated combustor 110.

Although FIG. 1 illustrates a plurality of circumferentially spaced combustors 110 and FIG. 2 shows a cross-section of a combustor 110 that may be considered a can combustor, the disclosed technology may be used in conjunction with other combustor systems including and not limited to annular or can combustor systems.

FIG. 2 is a cross-sectional side view of an embodiment of a combustor 110 of the combustion section 20 in FIG. 1. FIG. 2 illustrates the combustor 110 comprising a primary combustion system 22 and a secondary combustion system 24 within an assembly; as described in U.S. Pat No. 6,047,550 and U.S. Pat. No. 6,192,688. The combustor 110 comprises a plurality of micromixer slot injectors 200, and a transition piece 122, which generally allows for the generated combustion products to flow to the turbine nozzle 112.

The primary combustion system 22 may include a casing 126, an end cover 128, a plurality of start-up fuel nozzles 130, a plurality of premising fuel nozzles 116, a cap assembly 134, a flow sleeve 120, and a combustion liner 132 within the flow sleeve 120. An example of a cap assembly 134 is described in U.S. Pat. No. 5,274,991. Combustion in the primary combustion system 22 may occur within the combustion liner 132, Typically, combustion air is directed within the combustion liner 132 via the flow sleeve 120 and enters the combustion liner 132 through a plurality of openings formed in the cap assembly 134. The air may enter the combustion liner 132 under a pressure differential across the cap assembly 134 and mixes with fuel from the start-up fuel nozzles 130 and/or the premising fuel nozzles 116 within the combustion liner 132. Consequently, a combustion reaction occurs within the combustion liner 132 that releases heat energy mat drives the turbine section 18.

High-pressure air from the primary combustion system 22 may enter the How sleeve 120 and an impingement sleeve 118, from an annular plenum 144. The compressor section 16, represented by a series of vanes, blades, other compressor components 114 and a diffuser 136, supplies this high-pressure air. Each premixing fuel nozzle 116 may include a swirler 148, which may comprise a plurality of swirl vanes 150 that impart rotation to the entering air and allowing for the entering fuel to be distributed within the rotating air stream. The fuel and air then mix in an annular passage within the premix fuel nozzle 116 before reacting within the primary reaction zone 152.

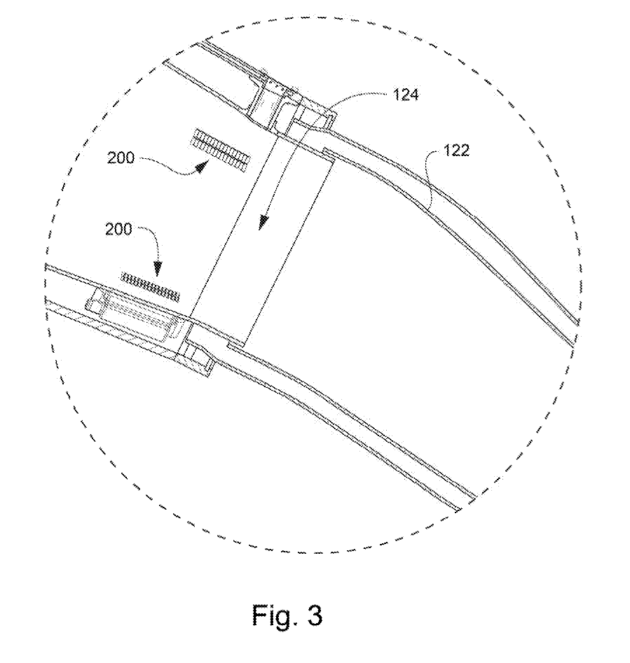

As illustrated in FIGS. 2 and 3, a plurality of micromixer slot injectors 200 may penetrate the transition piece 122 or combustion liner 132 and introduce additional fuel mixture into the secondary reaction zone 124 within the combustor 110. The combustion products exiting the primary reaction zone 152 may be at a thermodynamic stale that allows for the auto-ignition of the secondary fuel mixture. The resulting secondary hydrocarbon fuel oxidation reactions go to substantial completion in the transition piece 122. An embodiment of the secondary combustion system 24 and micromixer slot injector 200 may allow for burning a fuel different from the fuel burned within the primary combustion system 22. For example, the injector may allow for burning a synthetic fuel, syngas, or the like.

Referring to FIGS. 2 and 3, an embodiment of the disclosed technology may function with at least one micromixer slot injector 200. located within the combustion liner 132 or transition piece 122. An alternate embodiment of the disclosed technology may incorporate a plurality of micromixer slot injectors 200 positioned (e.g., circumferentially) in the combustion liner 132 or transition piece 122, as shown in FIGS. 2 and 3.

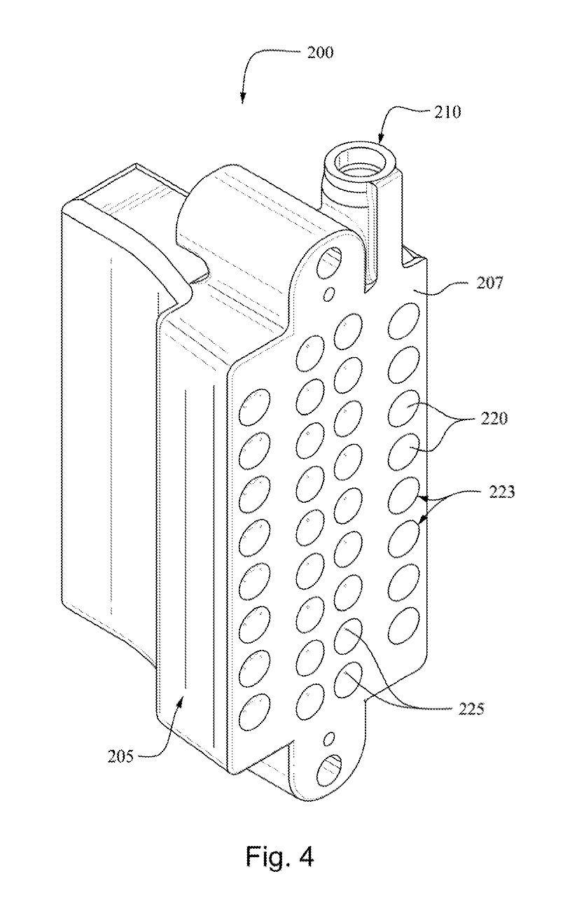

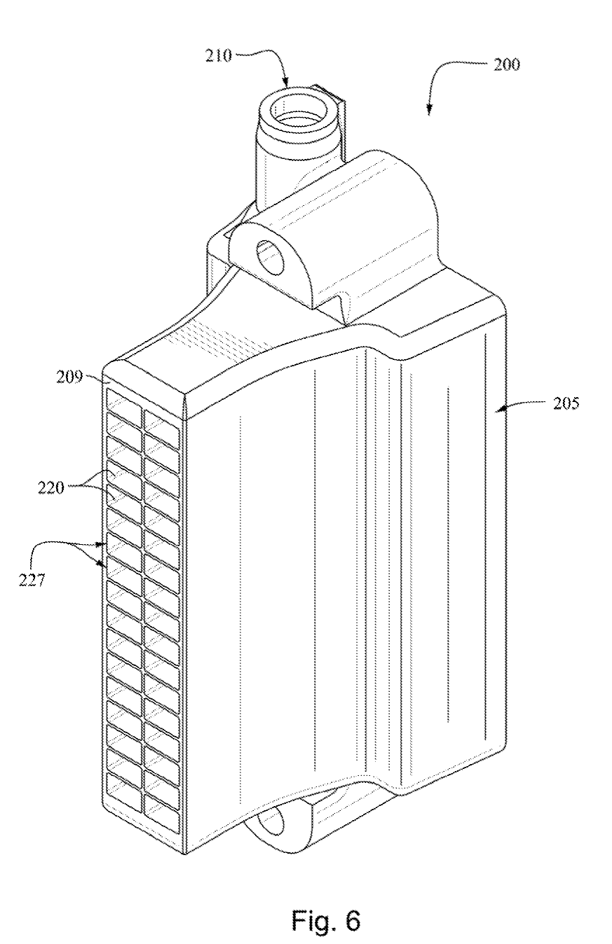

Turning to FIGS. 4-6, micromixer slot injector 200 is shown. Micromixer slot injector 200 is configured to receive supplies of air and fuel and to discharge a fuel/air mixture (e.g., a lean fuel/air mixture). Although the micromixer slot injector has a compact arrangement, since there is limited space in the circumferential regions of the combustion liner 132 and transition piece 122 downstream of the primary reaction zone, the configuration of the micromixer slot injector enables the production of a fuel/air mixture with a high degree of fuel/air mixedness. A well-mixed fuel air stream is preferable in order to minimize the formation of nitrogen oxide (NOx) emissions.

Micromixer slot injector 200 includes a body 205 having an upstream lace 207 and a downstream face 209, as shown in FIGS. 4-6. A plurality of premixing tubes 220 extend between upstream face 207 and downstream face 209, forming a plurality of corresponding air inlets 223 in the upstream face 207 and a plurality of corresponding outlets 227 in the downstream face. The air inlets 223 are arranged to receive a supply of air (e.g., bled off from compressor section 16).

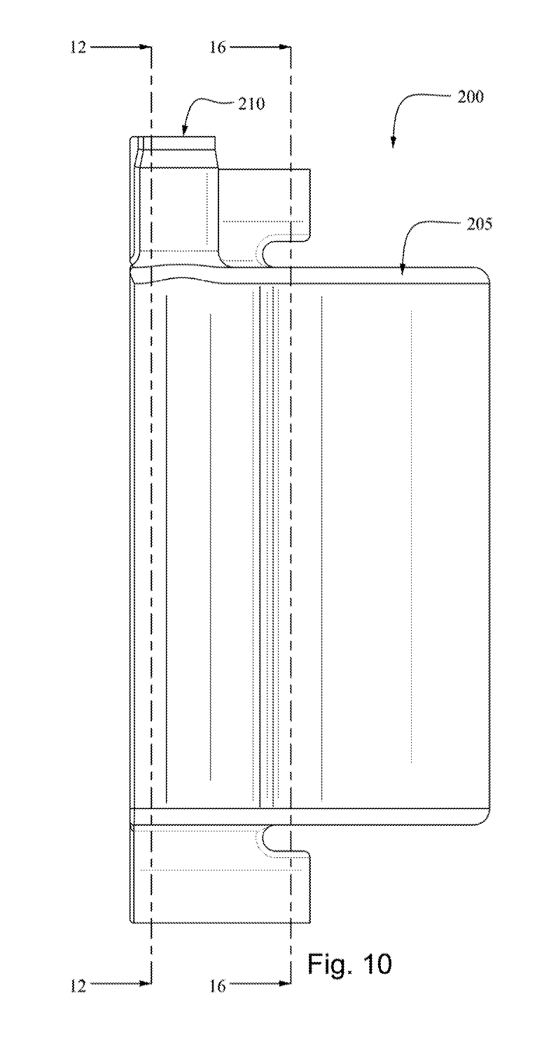

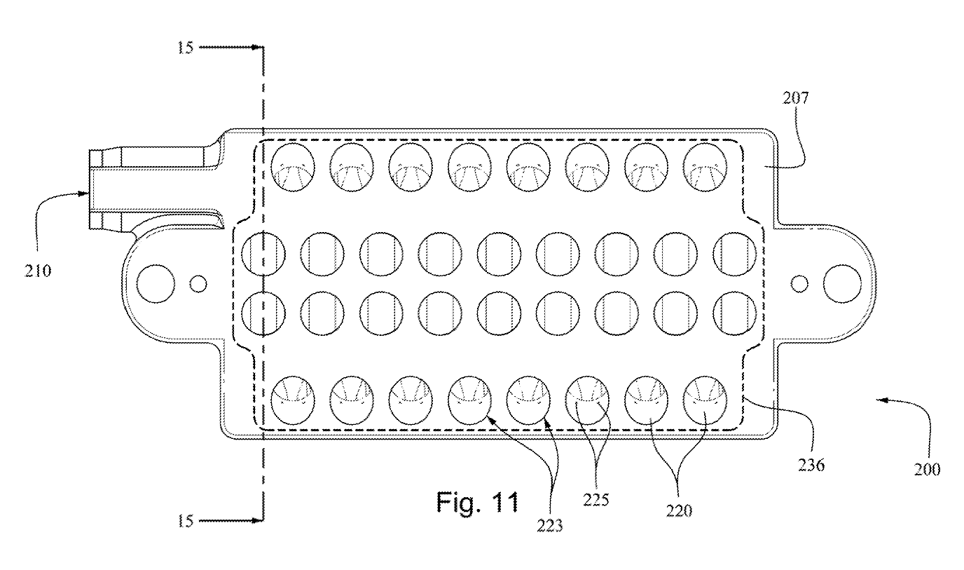

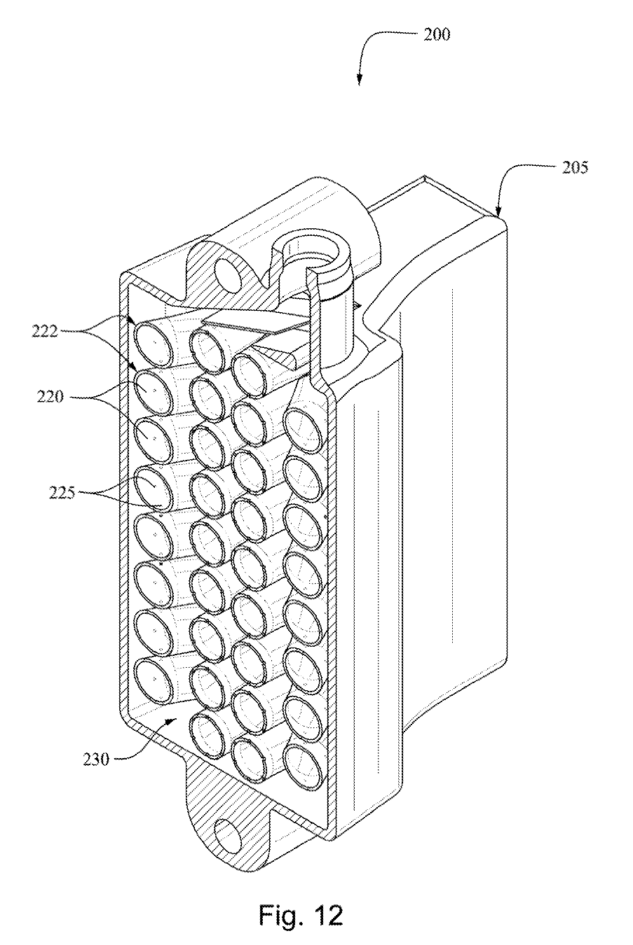

Referring to FIGS. 4-6 and 10, a fuel inlet 210 is formed in body 205 and configured to receive a supply of fuel. The fuel inlet is in fluid communication with a fuel plenum 230 within body 205. as best shown in FIG. 12. Fuel in the plenum 230 is received through a plurality of fuel holes 225 in each tube 220 to mix with air in the tubes. The plurality of premixing tubes 220 have a spaced-apart arrangement in the plenum 230 (which is toward the upstream face 207), as can be seen in FIG. 12. This arrangement enables the fuel to flow around all of the tubes so as to be evenly distributed among the tubes, which results in a well-mixed fuel/air stream.

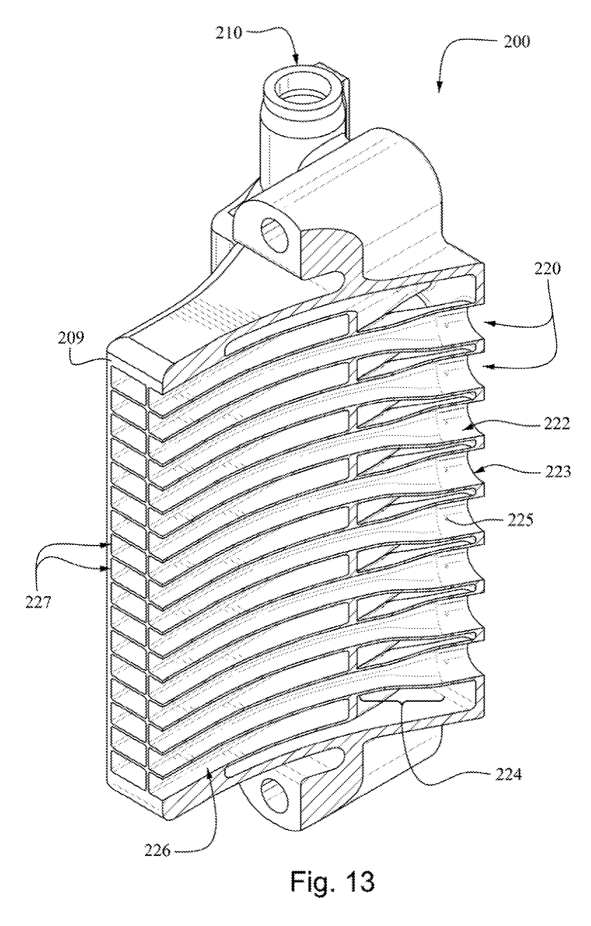

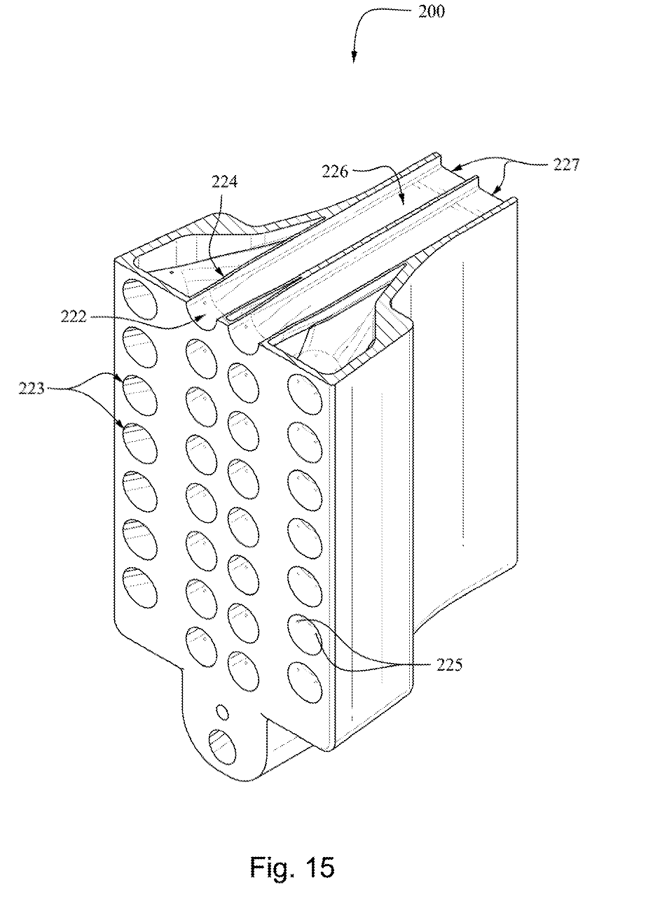

As best seen in FIGS. 13-15, each of the plurality of premixing tubes 220 has an intake end 222, a transition portion 224 and a discharge end 226. The intake end 222 includes the air inlet 223 which is formed in the upstream face 207 of body 205. The fuel holes 225 are also preferably formed in the intake ends 222 of the tubes. In the illustrated embodiment, the air inlet 223 of each tube has a non-rectilinear shape (e.g., an arcuate shape such as a circular shape). The non-rectilinear shape of the tubes continues into, and preferably through, the intake ends 222 of the tubes. The non-rectilinear shape facilities the spaced-apart arrangement of the tubes and the provision of a plurality of evenly distributed fuel holes 225 in the tubes.

Still referring to FIGS. 13-15, the transition portion 224 of each tube 220 extends between the intake end 222 and the discharge end 226. The transition portion 224 is also the portion of each tube where the tube transitions from the non-rectilinear shape to a non-circular shape (e.g., a rectilinear shape).

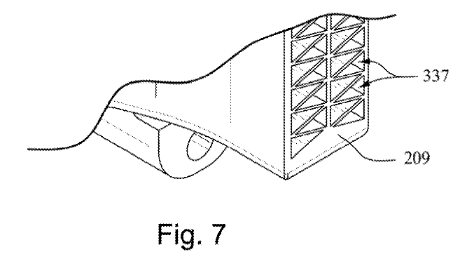

The discharge end 226 of each tube 220 extends from the transition portion 224 to outlet 227 which is formed in the downstream face 209 of the micromixer slot injector, as can be seen in FIGS. 13-15. The outlets 227 have a non-circular shape (e.g., a rectilinear shape such as rectangular). The non-circular shape of the outlets 227 facilitates a dense packing of the outlets on the downstream face 209. For example, each tube 220 may be bounded by at least one (e.g., 2 or 3) common wall with an immediately adjacent tube 220 such that no space exists between immediately adjacent tubes. In the illustrated example, each tube 220 (except for the four tubes at the upper and lower ends) has at least three common walls with immediately adjacent tubes. Those skilled in the art will recognize that the outlets could have other non-circular shapes, such as the triangular shaped outlets 337 shown in FIG. 7.

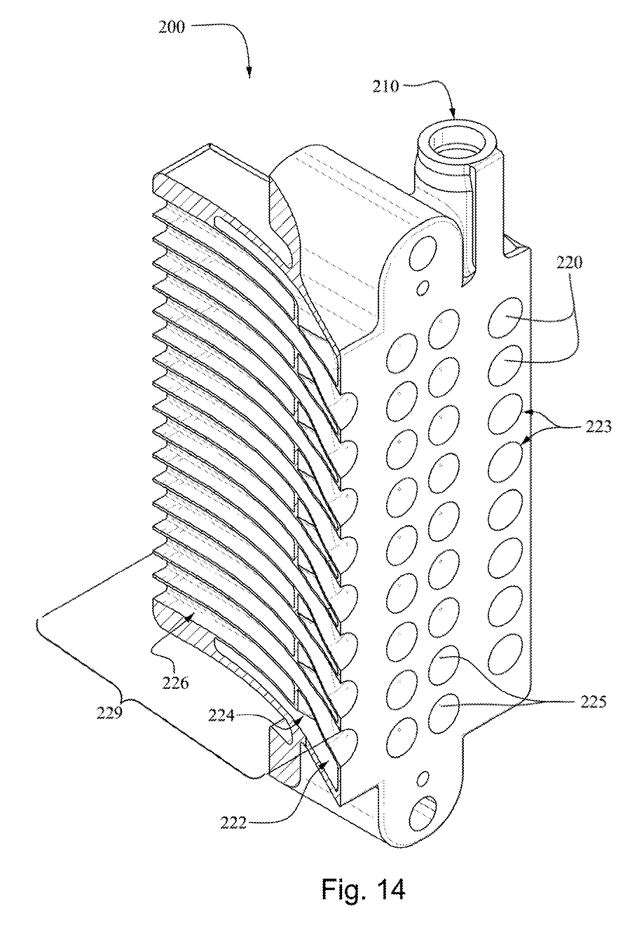

The intake end 222, transition portion 224 and discharge end 226 of each tube form a passageway 229 extending from the air inlet 223 to the outlet 227, as illustrated in FIG. 14. The length of each passageway 229 may be at least 10 times the diameter of the respective tube 220 to allow the fuel/air mixture to achieve sufficient premixing. The diameter of the tube 220 at the air inlet 223 may be between 0.25 and 0.45 inches (e.g.. 0.3-0.4 inches). Thus, micromixer slot injector 200 has a compact configuration. However, the arrangement of the air inlets 223 and the outlets 227 of the tubes 220 allow for a scalable configuration; thus, larger and/or smaller configurations are feasible.

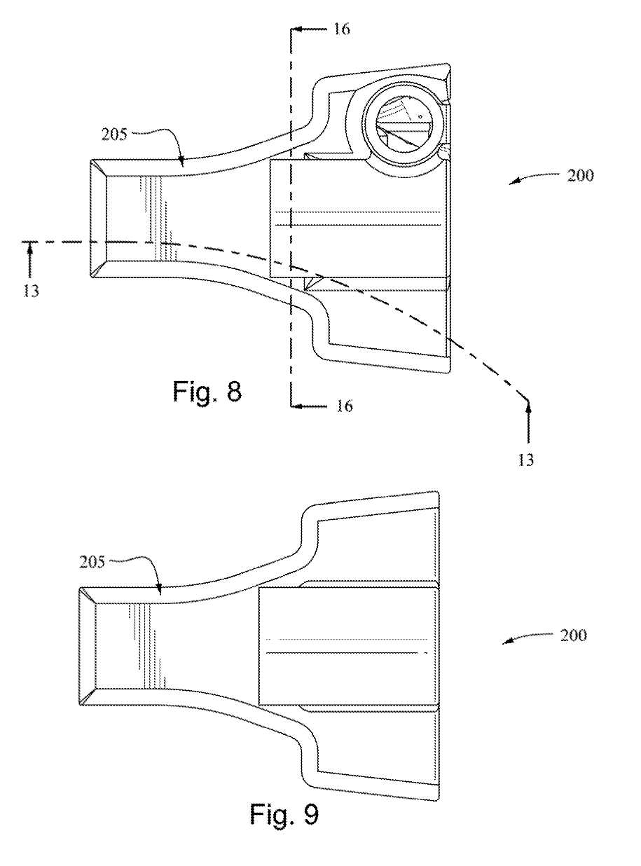

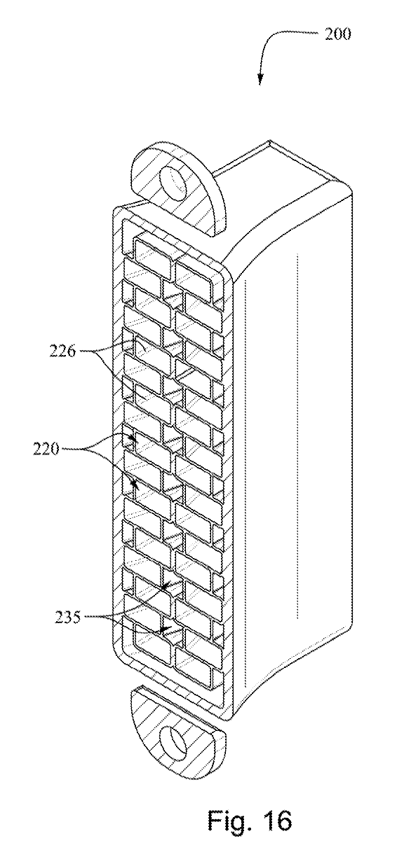

As can be seen in FIGS. 4-6, 8, 9 and 13-16, body 205 of micromixer slot injector 200 has a tapering profile from the upstream face 207 to the downstream face 209. That is, the micromixer slot injector tapers from an upstream end where the plurality of premixing tubes 220 are spaced-apart and have a first geometrical shape to a downstream end where the tubes are more densely packed and have a second, different geometrical shape. In FIG. 16, spaces 235 are shown between the discharge ends 226 of the tubes. The spaces 235 are smaller than the spaces between the tubes at the upstream face 207. At the downstream face 209, the spaces 235 are eliminated thereby allowing the outlets 227 of the tubes to be stacked without any wastage of space. Since there are no spaces between the outlets 227, the volume of flow exiting the outlets relative to the overall outlet area 236 (described below) is maximized. Those skilled in the art will recognize that the downstream face 209 could be arranged such that small spaces exist between the tubes.

As can be seen in FIGS. 12 and 13, tubes that are arranged side-by-side on the upstream face 207 are stacked vertically at the downstream face 209, resulting in an elongate structure at the downstream face.

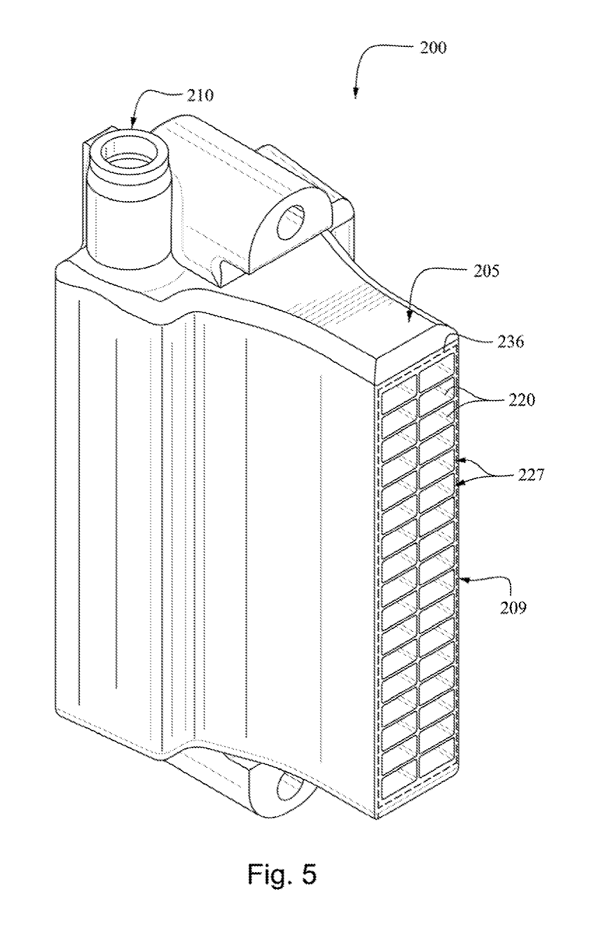

In other words, an overall inlet area 232 (FIG. 11), representing a surface area of upstream face 207 required to accommodate the air inlets 223 of the plurality of premixing tubes 220 in the spaced-apart arrangement is larger than an overall outlet area 236 (FIG. 5) representing a surface area of downstream face 209 required to accommodate the outlets of the plurality of premixing tubes in the densely paced arrangement. Thus, the overall outlet area 236 on downstream face 209 has an elongate structure that extends along a longitudinal axis of combustor 110. Those skilled in the art will recognize that the overall outlet area 236 may have a shape other than the slot shape formed by the elongate structure of the downstream face 209. For example, the overall outlet area 236 and the downstream face 209 could have a hexagonal shape.

The elongate structure of the overall outlet urea 236 facilitates the micromixer slot injector in achieving deep penetration of the fuel air mixture into the stream of combustion products produced by the primary combustion system. Deep penetration of the fuel/air mixture results in an efficient entrainment of the fuel/air mixture into the stream of combustion products, which minimizes the formation of NOx emissions.

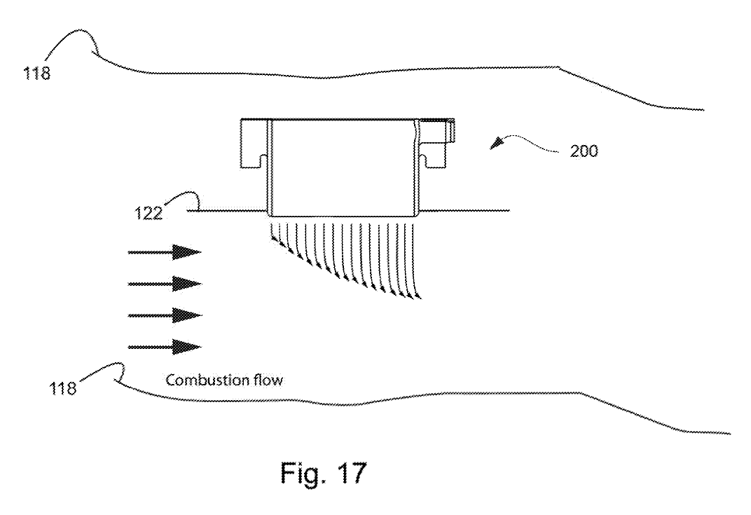

Turing to FIG. 17, it can be seen that outlets 227 that are relatively downstream in the direction of the combustion flow achieve deeper penetration into the combustion flow as compared to more upstream outlets. This occurs because the fuel/air mixture flowing from each relatively upstream outlet acts as a buffer for each downstream outlet enabling the How of each downstream outlet to be initially somewhat shielded from the combustion flow, thereby permitting progressively deeper penetration into the combustion flow. As a result, micromixer slot injector 200 can be scaled to achieve a desired penetration, since the greater the number of tubes in the micromixer slot injector the greater the length of the overall outlet area 236 in the direction of the combustion flow.

It is noted that micromixer slot injector 200 may be mounted flush or in an inserted arrangement in the combustion liner 132 or transition piece 122. A flush mounting, as shown in FIG. 3, may reduce the amount of heat transferred to the micromixer slot injector from the combustion flow, thereby requiring less energy to cool the micromixer slot injector. Other the other hand, penetration of the fuel air mixture into the combustion flow may be enhanced by inserting the micromixer slot injector a desired depth into the combustion flow. Overheating of the micromixer slot injector may be prevented by the flow of air and fuel which cool the micromixer slot injector as they pass through. In FIG. 17, micromixer slot injector 200 is shown slightly inserted into the transition piece 122.

While the invention has been described in connection with what is presently considered to be the most practical and preferred examples, it is to be understood that the invention is not to be limited to the disclosed examples, but on the contrary, is intended to cover various modifications and equivalent arrangements included within the spirit and scope of the appended claims.

What is claimed is:

1. A micromixer injector, comprising:
a fuel plenum to receive a supply of fuel;
a plurality of premixing tubes extending through the fuel plenum, each tube having an air inlet at an intake end of the tube and an outlet at a discharge end of the tube, the air inlet of each tube being eon figured to receive a supply of air, each tube having a plurality of fuel holes formed therein to receive the supply of fuel for mixing with the air in the rube; and
an upstream lace having the inlet of each tube formed therein, and a downstream face having the outlet of each tube formed therein.
wherein the air inlet of each tube has a first geometrical shape and the outlet of each tube has a second geometrical shape that is different from the first geometrical shape, and
wherein an overall inlet area of the plurality of premising tubes on the upstream-face is larger than an overall outlet area of the plurality of premixing tubes on the downstream lace such that the plurality of premixing tubes are relatively spaced-apart at the upstream face and more densely packed at the downstream face.

2. The micromixer injector of claim 1, wherein the downstream face has an elongate structure configured to extend along a longitudinal axis of a combustor.

3. The micromixer injector of claim 1, wherein the air inlet of each tube of the plurality of premixing tubes has a non-rectilinear shape.

4. The micromixer injector of claim 3, wherein the air inlet of each tube of the plurality of premixing tubes has an arcuate shape.

5. The micromixer injector of claim 1, wherein the outlet of each tube of the plurality of premixing tubes has a non-circular shape.

6. The micromixer injector of claim 5, wherein the outlet of each tube of the plurality of premixing tubes has a rectilinear shape.

7. The micromixer injector of claim 1, wherein the air inlet of each tube of the plurality of premixing tubes has a circular shape and the outlet of each tube has a rectilinear shape, and each tube has a transition portion wherein the tube transitions from a circular shape to a rectilinear shape.

8. The micromixer injector of claim 1, wherein immediately adjacent tubes of the plurality of premixing tubes are bounded by a common wall at the outlet of each tube such that no space exists between the immediately adjacent tubes at the outlet of each tube.

9. The micromixer injector of claim 1, further comprising a body having the upstream lace at a first end thereof and the downstream lace at an opposite second end thereof, the body tapering from the upstream face to the downstream face,

10. A combustor section, comprising:
a primary combustion system generating a stream of combustion products;
a secondary combustion system located downstream of the primary combustion system, the secondary combustion system including:
at least one micromixer injector to deliver a fuel/air mixture into the stream of combustion products, the at least one micromixer injector comprising:
a fuel plenum to receive a supply of fuel;
a plurality of premixing tubes extending through the fuel plenum, each tube having an air inlet at an intake end of the tube and an outlet at a discharge end of the tube, the air inlet of each tube being configured to receive a supply of air, each tube having a plurality of fuel holes formed therein to receive the supply of fuel for mixing with the air in the tube; and
an upstream face having the inlet of each tube formed therein, and a downstream face having the outlet of each tube formed therein,
wherein the air inlet of each tube has a first geometrical shape and the outlet of each tube has a second geometrical shape that is different from the first geometrical shape, and
wherein an overall inlet area of the plurality of premixing tubes on the upstream lace is larger than an overall outlet area of the plurality of premixing tubes on the downstream face such that the plurality of premixing tubes are relatively spaced-apart at the upstream face and more densely packed at the downstream face.

11. The combustor section of claim 10, wherein the overall outlet area has an elongate shape extending in a direction of How of the stream of combustion products,
wherein the number of premixing tubes in the at least one micromixer injector corresponds directly to a length of the elongate overall outlet area, and a first outlet arranged downstream in the direction of flow of the stream of combustion products relative to a second outlet achieves deeper penetration of the fuel/air mixture into the stream of combustion products.

12. The combustor section of claim 11, wherein the at least one micromixer injector is configured such that the greater the number of premixing tubes in the micromixer injector, the deeper the penetration of the fuel/air mixture into the stream of combustion products.

13. The combustor section of claim 10, wherein the downstream face has an

14. The combustor section of claim 10, wherein the air inlet of each tube of the plurality of premixing tubes has a non-rectilinear shape.

15. The combustor section of claim 14, wherein the air inlet of each tube of the plurality of premixing tubes has an arcuate shape.

16. The combustor section of claim 10, wherein the outlet of each tube of the plurality of premixing tubes has a non-circular shape.

17. The combustor section of claim 16, wherein the outlet of each tube of the plurality of premixing tubes has a rectilinear shape.

18. The combustor section of claim 19, wherein the air inlet, of each tube of the plurality of premixing tubes has a circular shape, and the outlet of each tube has a rectilinear shape, and each tube has a transition portion wherein the tube transitions from a circular shape to a rectilinear shape.

19. The combustor section of claim 10, wherein immediately adjacent tubes of the plurality of premising tubes are bounded by a common wall at the outlet of each tube such that no space exists between the immediately adjacent tubes at the outlet of each tube.

20. The combustor section of claim 10, said at least one micromixer injector further comprising a body having the upstream face at a first end thereof and the downstream face at an opposite second end thereof, the body tapering from the upstream face to the downstream face.
